(19) United States
(12) Patent Application Publication
(10) Pub. No.: US 2026/0348516 A1
(43) Pub. Date: Nov. 5, 2026

(54) TELEVISION MOUNT AND PLUG-IN ASSEMBLY THEREOF

(71) Applicant: Bestqi Innovation Technology (Shenzhen) Co., Ltd., Shenzhen (CN)

(72) Inventors: Changgan SHEN, Shenzhen (CN); Chengan LU, Shenzhen (CN)

(21) Appl. No.: 19/659,210

(22) Filed: Apr. 27, 2026

(30) Foreign Application Priority Data
Apr. 30, 2025 (CN) 202520875148.3

(51) Int. Cl. F16M 13/02; F16M 11/20

(52) U.S. Cl. CPC F16M 13/022; F16M 11/2092

(57) ABSTRACT

The present application provides a television mount and a plug-in assembly thereof. The plug-in assembly includes: a first plug-in member and a second plug-in member; the first plug-in member includes a first end and a second end, the first end is provided with a first port, the second plug-in member includes a third end and a fourth end, the third end is provided with a plug-in portion, the plug-in portion is configured to be plugged into the first port, the second end is provided with a blocking portion for preventing erroneous plugging of the second end, and/or the fourth end is provided with a blocking portion for preventing erroneous plugging of the fourth end. The plug-in assembly can prevent erroneous plugging, greatly reducing the probability of errors during installation by a user, improving installation accuracy and efficiency.

### CROSS REFERENCE TO RELATED APPLICATION

Pursuant to 35 U.S.C. § 119 and the Paris Convention, this application claims the benefit of Chinese Patent Application No. 202520875148.3 filed Apr. 30, 2025, the contents of which are incorporated herein by reference.

### TECHNICAL FIELD

The present application relates to the field of television mounts, and more specifically to a television mount and a plug-in assembly thereof.

### BACKGROUND

In order to reduce packaging volume, and to save packaging materials and overall transportation costs, existing television mounts typically divide long components into multiple short components. During use, the multiple short components are then spliced and plugged together to form a long component. Users are prone to making mistakes in the plugging direction during installation.

### SUMMARY

An embodiment of the present application aims to provide a television mount and a plug-in assembly thereof, to solve the problem in the prior art that plug-in assemblies are prone to being plugged in the wrong direction.

In order to achieve the above purpose, the technical solution adopted by the present application is to provide a plug-in assembly for a television mount, the plug-in assembly includes:
a first plug-in member; the first plug-in member including a first end and a second end, and the first end being provided with a first port; and
a second plug-in member; the second plug-in member including a third end and a fourth end, the third end being provided with a plug-in portion, the plug-in portion being configured to be plugged into the first port;
the second end is provided with a blocking portion configured for preventing erroneous plugging of the second end, and/or the fourth end is provided with a blocking portion configured for preventing erroneous plugging of the fourth end.

Optionally, the second end is provided with a second port, the second end is further provided with a first through hole, the first through hole penetrates through a side wall of the second port; and
the first through hole includes a first flange hole, a first flange portion is formed on an inner wall of the second port along a periphery of the first flange hole, and the first flange portion forms the blocking portion.

Optionally, the plug-in assembly further includes a connecting member;
the first end is provided with a second through hole, the third end is provided with a third through hole;
when the plug-in portion is plugged into the first port, the second through hole and the third through hole are aligned, and the connecting member is inserted through the second through hole and the third through hole.

Optionally, the third end is provided with a third port, and the third through hole penetrates through a side wall of the third port;
the third through hole includes a second flange hole, a second flange portion is formed on an inner wall of the third port along a periphery of the second flange hole, and an inner wall of the second flange portion is provided with an internal thread;
the connecting member includes a screw, and the screw is connected with the internal thread.

Optionally, the third end is provided with a reduced-diameter portion, and the reduced-diameter portion forms the plug-in portion.
The present application also provides a television mount, the television mount includes the plug-in assembly described above.

Optionally, the television mount includes a hanging strip assembly, the hanging strip assembly is provided with a hanging opening and a television mounting portion;and
the plug-in assembly is disposed along a horizontal direction, and the hanging strip assembly is hung on the plug-in assembly via the hanging opening.

Optionally, the television mount includes a plurality of plug-in assemblies, the plurality of plug-in assemblies include a first plug-in assembly and a second plug-in assembly, the first plug-in assembly and the second plug-in assembly are arranged along a height direction;
the hanging strip assembly includes a plurality of hanging openings, the plurality of hanging openings include a first hanging opening and a second hanging opening, the first hanging opening is hung on the first plug-in assembly, the second hanging opening is hung on the second plug-in assembly;
the hanging strip assembly includes a locking member, at least one of the first hanging opening and the second hanging opening is a lockable hanging opening, one end of the locking member is hinged to one side of the lockable hanging opening, and an other end of the locking member is detachably connected to an other side of the lockable hanging opening, so that the locking member locks the plug-in assembly within the lockable hanging opening.

Optionally, the television mount includes an adjustment assembly, the adjustment assembly includes a first adjustment bracket and a second adjustment bracket, and the first adjustment bracket is connected to the plug-in assembly;
the first adjustment bracket includes a hinge position and an adjustment hole arranged at an interval, the adjustment hole is an arc-shaped hole centered at the hinge position, one end of the second adjustment bracket is hinged at the hinge position, and the other end of the second adjustment bracket is provided with a guide member inserted through the arc-shaped hole.

Optionally, the television mount further includes a base fixing member, a first arm assembly, and a second arm assembly, each of the first arm assembly and the second arm assembly includes a first segment and a second segment hinged to each other;
the first segment of the first arm assembly and the first segment of the second arm assembly are both hinged to the second adjustment bracket, and the second segment of the first arm assembly and the second segment of the second arm assembly are both hinged to the base fixing member.
The beneficial effects of the television mount and the plug-in assembly thereof provided by the present application are: compared with the prior art, in the plug-in assembly according to the embodiment of the present application, the first end of the first plug-in member and the third end of the second plug-in member can be correctly plugged together, while the second end of the first plug-in member and/or the fourth end of the second plug-in member are/is provided with a blocking portion for blocking plugging, which can prevent erroneous plugging, greatly reducing the probability of errors during installation by a user, improving installation accuracy and efficiency. When installing the television mount, the user does not need to repeatedly attempt and confirm the plugging direction, reducing confusion and time costs during installation, and significantly enhancing the installation experience of the user. Furthermore, the correct connection of the plug-in assembly can improve the structural stability of the television mount, ensuring user safety.

### BRIEF DESCRIPTION OF THE DRAWINGS

In order to explain the technical solutions in the embodiments of the present application more clearly, the following briefly introduces the accompanying drawings required for describing the embodiments or the prior art. Apparently, the accompanying drawings described below are merely some embodiments of the present application. For those of ordinary skill in the art, other accompanying drawings can be obtained based on these accompanying drawings without creative efforts.

FIG. 1 is a schematic diagram of a plug-in assembly according to an embodiment of the present application;

FIG. 2 is a schematic diagram of a first plug-in member from one perspective according to an embodiment of the present application;

FIG. 3 is a schematic diagram of the first plug-in member from another perspective according to an embodiment of the present application;

FIG. 4 is a schematic diagram of a second plug-in member according to an embodiment of the present application;

FIG. 5 is a schematic cross-sectional view of a second end according to an embodiment of the present application;

FIG. 6 is a schematic cross-sectional view of a third end according to an embodiment of the present application;

FIG. 7 is a schematic diagram of a first plug-in member and a second plug-in member plugged in a wrong direction according to an embodiment of the present application;

FIG. 8 is a schematic diagram of a first plug-in member and a second plug-in member correctly installed according to an embodiment of the present application;

FIG. 9 is a schematic diagram of a television mount from one perspective according to an embodiment of the present application;

FIG. 10 is a schematic diagram of the television mount from another perspective according to an embodiment of the present application;

FIG. 11 is a schematic diagram of a hanging strip assembly according to an embodiment of the present application;

FIG. 12 is a schematic diagram of an adjustment assembly in an upwardly tilted state according to an embodiment of the present application;

FIG. 13 is a schematic diagram of the adjustment assembly in a downwardly tilted state according to an embodiment of the present application; and

FIG. 14 is a schematic diagram of a first arm assembly according to an embodiment of the present application.

In the Drawings, the reference signs are listed as follows:
plug-in assembly 1; first plug-in member 11; first end 111; second end 112; first port 113; second port 114; first through hole 115; first flange portion 116; second through hole 117; second plug-in member 12; third end 121; fourth end 122; plug-in portion 123; third through hole 124; second flange portion 125; connecting member 13; hanging strip assembly 2; hanging opening 21; television mounting portion 22; lockable hanging opening 23; locking member 24; adjustment assembly 3; first adjustment bracket 31; second adjustment bracket 32; hinge position 33; adjustment hole 34; adjustment knob 35; first arm assembly 4; second arm assembly 40; first segment 41; second segment 42; base fixing member 5.

### DETAILED DESCRIPTION OF EMBODIMENTS

In order to make the technical problems, technical solutions, and beneficial effects to be solved by the present application clearer, the present application is further described in detail below with reference to the accompanying drawings and embodiments. It should be understood that the specific embodiments described herein are only for explaining the present application and are not intended to limit the present application.

It should be noted that when a component is referred to as being "fixed to" or "disposed on" another component, it may be directly on the other component or indirectly on the other component. When a component is referred to as being "connected to" another component, it may be directly connected to the other component or indirectly connected to the other component.

It is to be understood that the terms "length," "width," "upper," "lower," "front," "rear," "left," "right," "vertical," "horizontal," "top," "bottom," "inner," "outer," and the like indicating orientations or positional relationships are based on the orientations or positional relationships shown in the drawings, and are merely for convenience of describing the present application and simplifying the description, and do not indicate or imply that the device or element referred to must have a specific orientation, be constructed and operate in a specific orientation, and therefore cannot be construed as limiting the present application.

Furthermore, the terms "first," "second" are used for descriptive purposes only and are not to be understood as indicating or implying relative importance or implicitly indicating the number of technical features indicated. Thus, features defined with "first," "second" may explicitly or implicitly include one or more of such features. In the description of the present application, "a plurality of" means two or more, unless otherwise specifically defined.

As an important support structure for carrying display devices, the design of a television mount needs to take into account both stability and portability. Traditional integrated mounts occupy a large amount of space during logistics transportation due to their overall large size, leading to high packaging material costs and transportation expenses. In order to solve this problem, modern television mounts widely adopt a modular design concept, dividing originally long structural components such as beams and columns into several short components, and achieving detachable splicing through precisely designed plug-in interfaces.

The core advantage of this split design is significantly reducing packaging volume. Taking the beam component of a television mount as an example, the beam component may be divided into left and right parts, connected by a plug-in sleeve structure. Similarly, in a floor-standing television mount, the main column may also be divided into upper and lower sections to control the length of each section.

However, this design also introduces assembly risks while improving portability. If a user does not carefully read the instructions or study the assembly details during initial installation, they are prone to installing the plug-in components in reverse. If the plug-in components of a modular television mount are installed in reverse, it can lead to multiple negative effects: firstly, incomplete interface engagement will significantly reduce the load-bearing strength of the component, affecting support stability; secondly, the stress concentration caused by forced reverse installation can create hidden cracks at the interface, which are prone to breakage after long-term use; additionally, the user needs to repeatedly disassemble and reassemble, resulting in increased operational time and decreased product satisfaction. Such installation issues have become a common complaint in the television mount field.

As shown in FIG. 1 - FIG. 8. The plug-in assembly 1 according to an embodiment of the present application is described below. The plug-in assembly 1 includes:
a first plug-in member 11; the first plug-in member 11 including a first end 111 and a second end 112, the first end 111 being provided with a first port 113;
a second plug-in member 12; the second plug-in member 12 including a third end 121 and a fourth end 122, the third end 121 being provided with a plug-in portion 123, the plug-in portion 123 being configured to be plugged into the first port 113;
the second end 112 is provided with a blocking portion configured for preventing erroneous plugging of the second end 112, and/or the fourth end 122 is provided with a blocking portion configured for preventing erroneous plugging of the fourth end 122.
The first plug-in member 11 and the second plug-in member 12 in this embodiment are both components of the television mount, which are assembled by plugging into each other. The first plug-in member 11 and the second plug-in member 12 can be two sections of a beam, two sections of a column, or other components requiring mutual plug-in assembly in the television mount. The first plug-in member 11 and the second plug-in member 12 are usually rod-shaped, but may also have other shapes. In practical television mounts, the first plug-in member 11 and the second plug-in member 12 are often structures such as round tubes, square tubes, or other profiles, thereby reducing weight while ensuring strength.

In this embodiment, it is necessary to plug the first end 111 of the first plug-in member 11 and the third end 121 of the second plug-in member 12 together to achieve correct assembly. However, during actual operation, users may incorrectly plug the second end 112 of the first plug-in member 11 with the third end 121 of the second plug-in member 12, the second end 112 of the first plug-in member 11 with the fourth end 122 of the second plug-in member 12, or the first end 111 of the first plug-in member 11 with the fourth end 122 of the second plug-in member 12, and other reverse installation scenarios. The plug-in assembly 1 of this embodiment is designed to solve this problem.

Specifically, in this embodiment, in order to enable plugging between the first end 111 of the first plug-in member 11 and the third end 121 of the second plug-in member 12, the first end 111 is provided with a first port 113, serving as an interface for receiving the plug-in portion 123 of the second plug-in member 12. The third end 121 is equipped with a plug-in portion 123, which is specifically used to be inserted into the first port 113 of the first plug-in member 11, to achieve the correct connection of the plug-in assembly 1. For example, in a beam plug-in scenario of the television mount, the first port 113 of the first plug-in member 11 can be designed as a rectangular slot, and the plug-in portion 123 at the third end 121 of the second plug-in member 12 can be designed as a rectangular tongue matching the shape of the first port 113. The thickness and length of the tongue precisely correspond to the slot, so as to provide reliable support and connection strength after insertion.

The second end 112 is the opposite end of the first plug-in member 11 relative to the first end 111, and the second end 112 is provided with a blocking portion. The function of this blocking portion is to prevent the second end 112 of the first plug-in member 11 from being incorrectly used for plugging, avoiding reverse plugging with the second plug-in member 12. It can prevent the second end 112 of the first plug-in member 11 from being plugged with the third end 121 and the fourth end 122 of the second plug-in member 12.

The fourth end 122 of the second plug-in member 12 is similar to the second end 112 of the first plug-in member 11. The fourth end 122 can be provided with a blocking portion to prevent the fourth end 122 of the second plug-in member 12 from being incorrectly used for plugging with the first plug-in member 11. It can prevent the fourth end 122 of the second plug-in member 12 from being plugged with the first end 111 and the second end 112 of the first plug-in member 11.

It should be noted here that during actual design, a blocking portion may be provided only at the second end 112, only at the fourth end 122, or at both the second end 112 and the fourth end 122. The blocking portion can adopt a protruding structure, a special-shaped structure, etc. For example, a protruding structure is provided at the second end 112 or the fourth end 122 to block plugging by other plug-in members; alternatively, the second end 112 or the fourth end 122 is designed as a special-shaped structure that is significantly different from other ends of the plug-in member, making it completely impossible to achieve plugging.

By providing a blocking portion at the second end 112 of the first plug-in member 11 and/or the fourth end 122 of the second plug-in member 12, this embodiment constructs a physical error-proofing mechanism. During the actual installation of the television mount, if a user inadvertently plugs the first plug-in member 11 and the second plug-in member 12 in reverse, the blocking portion will immediately take effect, preventing the plugging process from continuing. For example, when the user attempts to insert the fourth end 122 of the second plug-in member 12 into the first port 113 of the first plug-in member 11, the blocking portion of the fourth end 122 will interfere with the structure around the first port 113, preventing the insertion action from being completed, thereby effectively avoiding assembly errors caused by reverse plugging. This design greatly reduces the probability of errors during installation by the user, improving installation accuracy and efficiency.

Because the plug-in assembly 1 can effectively prevent reverse plugging, the user does not need to repeatedly try and confirm the plugging direction when installing the television mount, reducing confusion and time costs during installation. For non-professional users, this simple and intuitive error-proofing design makes the assembly of the television mount easier and more convenient, significantly enhancing the installation experience of the user.

Correct plugging is key to ensuring the structural stability of the television mount. If the first plug-in member 11 and the second plug-in member 12 are plugged in reverse, it may lead to issues such as loose connection and uneven stress distribution, affecting the support effect of the mount for the television, and even posing safety hazards. The reverse-plugging prevention design of the plug-in assembly 1 ensures that during installation, each component is always connected in the correct manner, thereby providing a stable and reliable structure for the television mount and ensuring user safety.

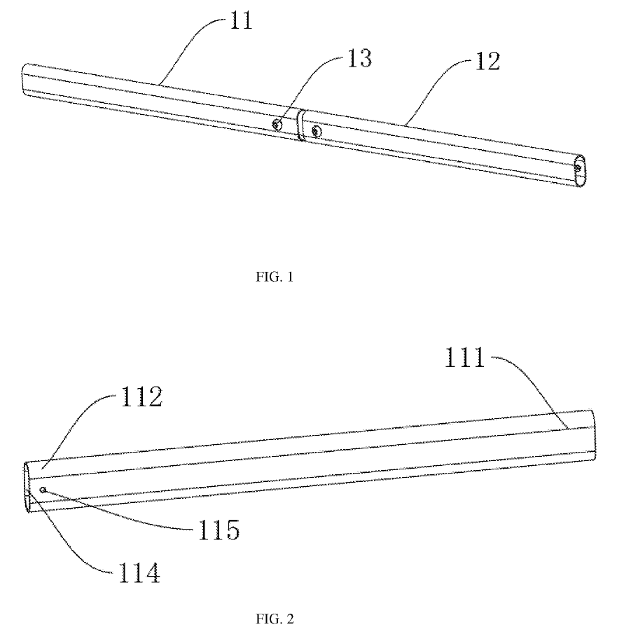

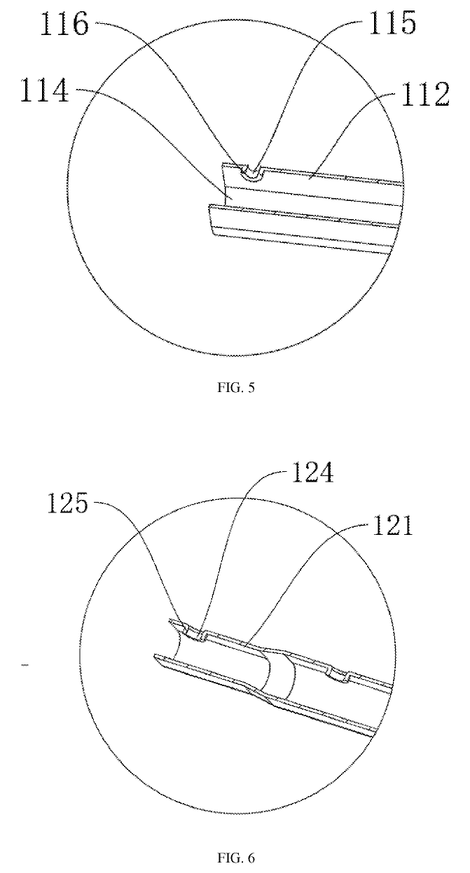

As shown in FIG. 2, FIG. 5, and FIG. 7, in some embodiments of the present application, the second end 112 is provided with a second port 114, the second end 112 is further provided with a first through hole 115, the first through hole 115 penetrates through a side wall of the second port 114; the first through hole 115 includes a first flange hole, a first flange portion 116 is formed on an inner wall of the second port 114 along a periphery of the first flange hole, and the first flange portion 116 forms the blocking portion.

As mentioned above, in actual television mounts, the first plug-in member 11 and the second plug-in member 12 are often structures such as round tubes, square tubes, or other profiles. Therefore, the first end 111 and the second end 112 of the first plug-in member 11 are usually similar, that is, the second end 112is also provided with a second port 114, which is why the second end 112 is prone to being plugged incorrectly.

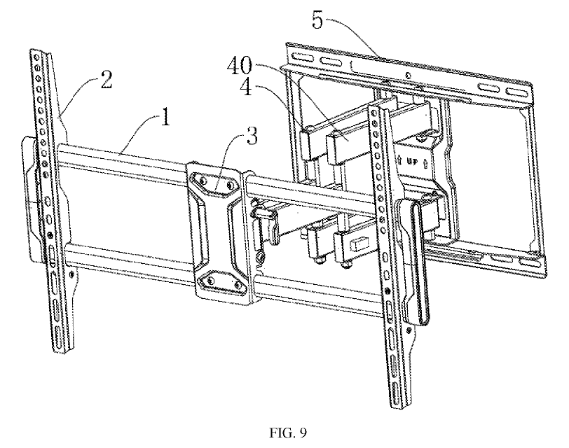

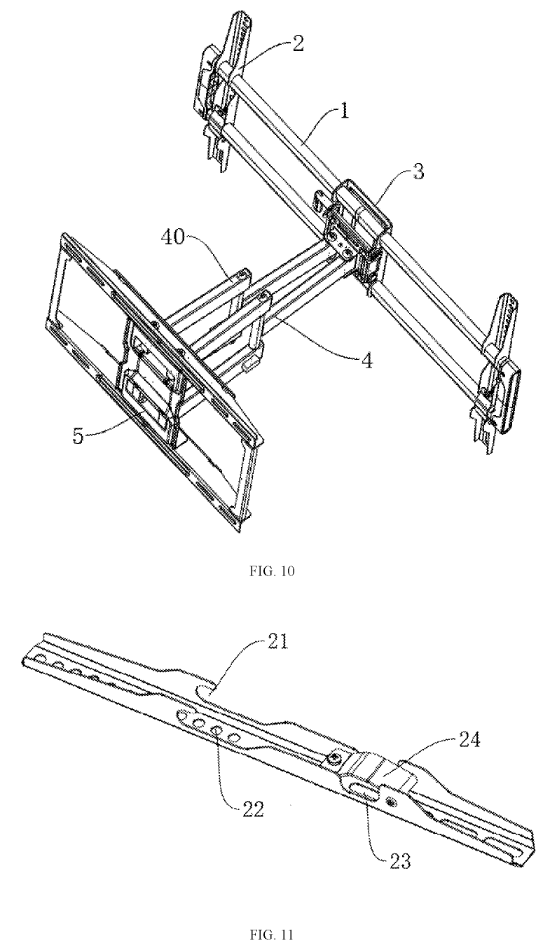

The ends of the first plug-in member 11 are typically connected to other components, such as end caps, decorative pieces, or functional parts. In this case, in this embodiment, the second end 112 of the first plug-in member 11 is further provided with a first through hole 115. The first through hole 115 is a through structure that penetrates from one side of the side wall of the second port 114 to the other side. The side wall here refers to the wall surface surrounding the opening of the second port 114. For example, if the second port 114 is an end hole of a square tube, then its square columnar side surface is the side wall, and the first through hole 115 is a hole laterally opened in this cylindrical side surface. The first through hole 115 allows for the fixation of other components. In the embodiment shown in FIG. 9, a decorative cover is fixed to the second end 112 by screws. Similarly, the fourth end 122 of the second plug-in member 12 can also be provided with a similar flange hole for installing a decorative cover.

In this embodiment, the first through hole 115 is a first flange hole. The flange hole is a special structure formed by performing flanging processing on the hole wall of an existing through hole. The flanging processing refers to folding part of the material of the hole wall along a specific direction (e.g., perpendicular to the plane of the hole wall) using processes such as stamping or forging, causing the hole wall to locally form a bend or protrusion, i.e., a flange portion. In order to improve the processing efficiency of the flange hole, the flange hole can be formed using a stamping process, where the punching needle adopts a stepped structure: the front segment has a smaller diameter than the rear segment, with a transitional slope between them. The front segment punches the hole, and the rear segment performs the flanging, completing the process in one operation.

This structure can enhance the strength around the hole and also create conditions for the formation of other structures. For example, in the embodiment, the first flange portion 116 of the first flange hole can facilitate the connection of a screw.

The first flange portion 116 of the first flange hole is located on the inner wall of the second port 114. Here, the inner wall refers to the wall surface surrounding the interior of the second port 114. Such an arrangement not only ensures the aesthetics of the outer periphery of the second end 112 but also allows the first flange portion 116 to function as a blocking portion. As shown in FIG. 7, if an attempt is made to reversely insert the third end 121 of the second plug-in member 12 into the second port 114 of the first plug-in member 11, the protruding structure of the first flange portion 116 will hinder the smooth insertion of the third end 121, thereby achieving the effect of preventing reverse plugging.

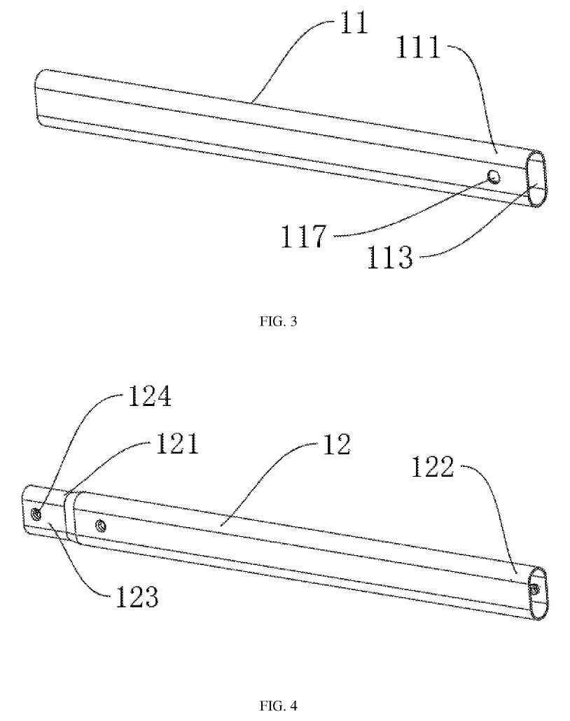

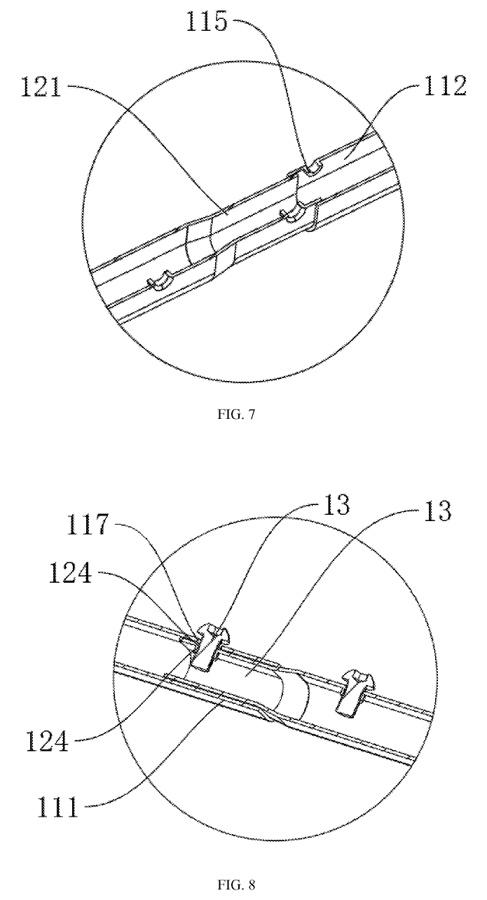

As shown in FIG. 3, FIG. 4, FIG. 6, and FIG. 8, in some embodiments of the present application, the plug-in assembly 1 further includes a connecting member 13; the first end 111 is provided with a second through hole 117, the third end 121 is provided with a third through hole 124; when the plug-in portion 123 is plugged into the first port 113, the second through hole 117 and the third through hole 124 are aligned, and the connecting member 13 is inserted through the second through hole 117 and the third through hole 124.

Considering that the first plug-in member and the second plug-in member might have a risk of dislodging after being plugged together, the plug-in assembly 1 of this embodiment further includes a connecting member 13. The connecting member 13 serves to tightly fix the first plug-in member 11 and the second plug-in member 12 together, so as to form a stable overall structure to meet the connection strength requirements of the television mount when bearing the television.

In order to enable the connection through the connecting member 13, a second through hole 117 is specifically provided at the first end 111 of the first plug-in member 11; In this case, a third through hole 124 is correspondingly provided at the third end 121 of the second plug-in member 12. As shown in FIG. 8, when the plug-in portion 123 of the second plug-in member 12 is correctly inserted into the first port 113 of the first plug-in member 11, the second through hole 117 at the first end 111 and the third through hole 124 at the third end 121 will be aligned, that is, the centerlines of the two through holes are on the same straight line. In this state, the connecting member 13 can smoothly pass through the second through hole 117 and the third through hole 124. The connecting member 13 can be a bolt, a screw, a pin, or other components. For example, if the connecting member 13 is a bolt, after the two plug-in members are correctly plugged, the bolt can sequentially pass through the aligned second through hole 117 and third through hole 124 and then be tightened with a nut, thereby firmly fixing the first plug-in member 11 and the second plug-in member 12 together, and effectively preventing relative displacement during use.

By having the connecting member 13 pass through the aligned second through hole 117 and third through hole 124 to tightly connect the first plug-in member 11 and the second plug-in member 12, the connection stability of the plug-in assembly 1 is greatly enhanced. This stable connection method effectively resists various external forces (such as gravity, vibration, etc) exerted on the television mount when bearing the television, ensuring that there are no safety hazards due to component loosening during long-term use.

As shown in FIG. 6 and FIG. 8, in some embodiments of the present application, the third end 121 is provided with a third port, the third through hole 124 penetrates through a side wall of the third port; the third through hole 124 includes a second flange hole, a second flange portion 125 is formed on an inner wall of the third port along a periphery of the first flange hole, and an inner wall of the second flange portion 125 is provided with an internal thread; the connecting member 13 includes a screw, and the screw is connected with the internal thread.

In this embodiment, similar to the first plug-in member 11, the third end 121 of the second plug-in member 12 is provided with a third port, and the third through hole 124 penetrates through the side wall of the third port. The third through hole 124 is also a second flange hole. The second flange portion 125 of the second flange hole is located on the inner wall of the third port, which can prevent the second flange portion 125 from obstructing the mutual plugging of the first plug-in member 11 and the second plug-in member 12. The inner wall of the second flange portion 125 is used to provide internal threads, facilitating the connection of the connecting member 13.

The connecting member 13 is a screw. When the first plug-in member 11 and the second plug-in member 12 are correctly plugged (i.e., when the plug-in portion 123 is fully inserted into the first port 113), the second through hole 117 and the third through hole 124 are aligned. In this case, the screw is inserted through the second through hole 117 at the first end 111 of the first plug-in member 11 and then threadedly connected with the internal threads on the inner wall of the second flange portion 125 at the third end 121 of the second plug-in member 12. By rotating the screw, it gradually screws into the internal threads, thereby tightly fixing the first plug-in member 11 and the second plug-in member 12 together.

As shown in FIG. 4, in some embodiments of the present application, the third end 121 is provided with a reduced-diameter portion, and the reduced-diameter portion forms the plug-in portion 123.

In this embodiment, the reduced-diameter portion provided at the third end 121 of the second plug-in member 12 serves to form the plug-in portion 123. The reduced-diameter portion means that the size of this part is reduced compared to other parts of the second plug-in member 12. For example, if the second plug-in member 12 is cylindrical overall, then at the third end 121, its diameter gradually decreases to form a reduced-diameter shape. The shape and size of this reduced-diameter portion are designed based on the first port 113 at the first end 111 of the first plug-in member 11, aiming to fit tightly into the first port 113 to achieve connection.

The provision of the reduced-diameter portion allows the first plug-in member 11 and the second plug-in member 12 to maintain the same external dimensions, forming a uniform integral component after mutual connection. The reduced-diameter portion can also aid in plugging identification. By providing the reduced-diameter portion at the third end 121 of the second plug-in member 12, the user is reminded to use the reduced-diameter portion of the third end 121 for plugging, reducing the likelihood of using the fourth end 122 for plugging.

Based on the plug-in assembly 1 in the above embodiments, the present application also provides a television mount. The television mount may include the plug-in assembly 1 according to the above embodiments. For example, in some large or custom television mounts, the beam may need to be fabricated and installed in sections due to its large size. The plug-in assembly 1 can be used for connecting the beam sections, meaning the first plug-in member 11 and the second plug-in member 12 are two adjacent sections of the multi-section beam, assembled by plugging them together to form a complete beam. Furthermore, the plug-in assembly 1 described above can also be used for connecting column sections, connecting beams and columns, connecting the base and the main body of the mount, and other various locations.

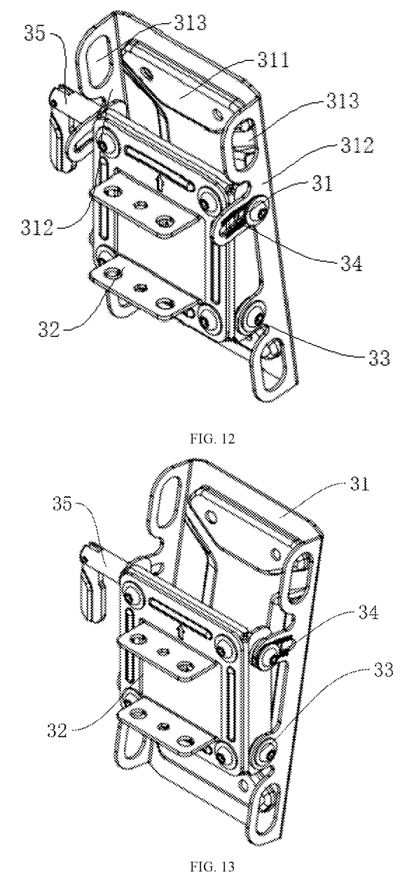

As shown in FIG. 9, FIG. 10, and FIG. 11, in some embodiments of the present application, the television mount includes a hanging strip assembly 2, the hanging strip assembly 2 is provided with a hanging opening 21 and a television mounting portion 22; the plug-in assembly 1 is disposed along a horizontal direction, and the hanging strip assembly 2 is hung on the plug-in assembly 1 through the hanging opening 21.

In this embodiment, the plug-in assembly 1 essentially serves as a beam. After the television mount is assembled, the television mount is disposed along the horizontal direction. In addition to the plug-in assembly 1, the television mount includes a hanging strip assembly 2. The hanging strip assembly 2 includes a hanging opening 21 and a television mounting portion 22. The hanging opening 21 can be hung on the plug-in assembly 1. For example, the hanging opening 21 can be designed as a groove or hook shape matching the plug-in assembly 1, so as to enable connection between the hanging opening 21 and the plug-in assembly 1. The television mounting portion 22 is used for mounting the television, and the television mounting portion 22 has corresponding mounting holes or fixing structures that can adapt to the mounting interfaces on the back of different televisions, ensuring the television can be securely installed on the hanging strip assembly 2.

The plug-in assembly 1 is formed by plugging the first plug-in member 11 and the second plug-in member 12 together, resulting in a longer length. The hanging strip assembly 2 is hung on the plug-in assembly 1 through the hanging opening 21, allowing the hanging strip assembly 2 to move along the plug-in assembly 1, thus adapting to televisions of different sizes or specifications. The number of hanging strip assemblies 2 can be one or more. For example, in the embodiment shown in FIG. 9, two hanging strip assemblies 2 are provided, and the spacing between the two hanging strip assemblies 2 can be adjusted to fit televisions of different sizes.

As shown in FIG. 9 and FIG. 10, in some embodiments of the present application, the television mount includes a plurality of plug-in assemblies 1, the plurality of plug-in assemblies 1 include a first plug-in assembly 1 and a second plug-in assembly 1, the first plug-in assembly 1 and the second plug-in assembly 1 are arranged along a height direction;
the hanging strip assembly 2 includes a plurality of hanging openings 21, the plurality of hanging openings 21 include a first hanging opening and a second hanging opening, the first hanging opening is hung on the first plug-in assembly 1, and the second hanging opening is hung on the second plug-in assembly 1;
the hanging strip assembly 2 includes a locking member 24, at least one of the first hanging opening and the second hanging opening is a lockable hanging opening 23, one end of the locking member 24 is hinged to one side of the lockable hanging opening 23, and the other end of the locking member 24 is detachably connected to the other side of the lockable hanging opening 23, so that the locking member 24 locks the plug-in assembly 1 within the lockable hanging opening 23.

In this embodiment, the television mount includes two plug-in assemblies 1, namely a first plug-in assembly 1 and a second plug-in assembly 1. The first plug-in assembly 1 and the second plug-in assembly 1 are arranged sequentially along the height direction, thereby providing two hanging positions for the hanging strip assembly 2 in the height direction.

The hanging strip assembly 2 includes two hanging openings matched with the two plug-in assemblies 1, i.e., a first hanging opening and a second hanging opening. The first hanging opening is hung on the first plug-in assembly 1, and the second hanging opening is hung on the second plug-in assembly 1, which can prevent the television from swinging and improve stability.

The hanging strip assembly 2 is equipped with a locking member 24, and at least one of the first hanging opening and the second hanging opening is a lockable hanging opening 23. For example, the first hanging opening can be a lockable hanging opening 23, or the second hanging opening can be a lockable hanging opening 23, or both the first and second hanging openings can be lockable hanging openings 23. One end of the locking member 24 is hinged to one side of the lockable hanging opening 23, that is, the locking member 24 can rotate about the hinge point. The other end of the locking member 24 is detachably connected to the other side of the lockable hanging opening 23, for example, by a snap fit, bolt, etc. When locking is required, the locking member 24 is rotated about the hinge point to cover the portion of the plug-in assembly 1 within the lockable hanging opening 23, and then the other end of the locking member 24 is connected and fixed to the other side of the lockable hanging opening 23, thereby firmly locking the plug-in assembly 1 within the lockable hanging opening 23, preventing accidental loosening or detachment of the hanging portion.

The provision of the locking member 24 significantly enhances the stability of the connection between the hanging opening 21 and the plug-in assembly 1. In daily use, the television mount may be subject to external forces such as vibrations or impacts. A simple hanging connection might become loose. The lockable hanging opening 23, through the locking member 24, tightly locks the plug-in assembly 1 inside, so as to effectively prevent loosening or detachment of the hanging portion due to external forces, and to ensure the television mount stably supports the television under various conditions and ensuring user safety.

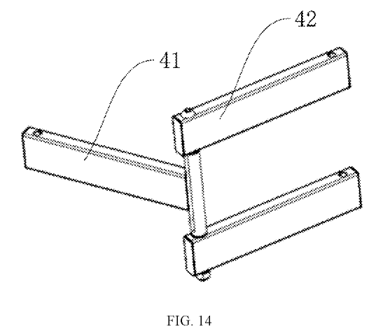

As shown in FIG. 10, FIG. 12, and FIG. 13, in some embodiments of the present application, the television mount includes an adjustment assembly 3, the adjustment assembly 3 includes a first adjustment bracket 31 and a second adjustment bracket 32, the first adjustment bracket 31 is connected to the plug-in assembly 1 through the connecting member 13 of the plug-in assembly 1;
the first adjustment bracket 31 includes a hinge position 33 and an adjustment hole 34 arranged at an interval, the adjustment hole 34 is an arc-shaped hole centered at the hinge position 33, one end of the second adjustment bracket 32 is hinged at the hinge position 33, and the other end has a guide member inserted through the arc-shaped hole.

In this embodiment, the television mount is equipped with an adjustment assembly 3, which includes a first adjustment bracket 31 and a second adjustment bracket 32. The first adjustment bracket 31 is connected to the plug-in assembly 1 through the connecting member 13 (e.g., the screw mentioned earlier) of the plug-in assembly 1. This means the first adjustment bracket 31 can utilize the existing connection structure of the plug-in assembly 1 to be stably installed on the corresponding position of the television mount, so as to provide a foundation for subsequent adjustment functions. Besides the through hole used to connect the first plug-in member 11 and the second plug-in member 12, additional through holes can be provided on the first plug-in member 11 or the second plug-in member 12 for connection with the first adjustment bracket 31 to improve connection stability.

In some embodiments, the first adjustment bracket 31 includes a main body 311 and two side plates 312. The two side plates 312 are all connected to the main body 311 and are spaced apart in an extending direction of the plug-in assembly 1. Each side plate 312 is provided with a positioning hole 313 for allowing the plug-in assembly 1 to pass through. The plug-in assembly 1 can pass through the positioning holes 313 of the two side plates 312 and be fixed to the main body 311 by screws, thereby achieving the installation positioning and fixation between the plug-in assembly 1 and the first adjustment bracket 31.

The first adjustment bracket 31 is provided with a hinge position 33 and an adjustment hole 34 spaced apart. One end of the second adjustment bracket 32 is hinged to the hinge position 33 of the first adjustment bracket 31, so as to achieve a rotatable connection. The other end is provided with a guide member, which can be inserted through the arc-shaped adjustment hole 34 of the first adjustment bracket 31. When the second adjustment bracket 32 rotates about the hinge position 33, the guide member moves along the arc within the arc-shaped hole, allowing the first adjustment bracket 31 to adjust its angle relative to the second adjustment bracket 32. This enables the television mount to achieve angular adjustment. Users can rotate the second adjustment bracket 32 as needed for optimal viewing, causing the guide member to move within the arc-shaped hole, thereby changing the included angle between the second adjustment bracket 32 and the first adjustment bracket 31. For example, when watching different types of programs or adapting to different viewing positions, the user can flexibly adjust the angle of the television mount for the best viewing experience. The adjustment direction is determined by the hinge axis direction. For example, if the hinge axis is horizontal, the pitch angle of the television can be adjusted; if the hinge axis is vertical, the yaw angle of the television can be adjusted.

In order to ensure stability after adjustment, an adjustment knob 35 can be connected to the guide member. When angle adjustment is needed, the adjustment knob 35 is loosened; after the television angle is adjusted, the adjustment knob 35 is tightened, allowing the television to maintain the adjusted angle.

In the embodiment shown in FIG. 12 and FIG. 13, the tilt degree of the television can be adjusted through the first adjustment bracket 31 and the second adjustment bracket 32. For example, as shown in FIG. 12, the first adjustment bracket 31 tilts upward relative to the second adjustment bracket 32, which can tilt the television connected through the plug-in assembly 1 upward. As shown in FIG. 13, the first adjustment bracket 31 tilts downward relative to the second adjustment bracket 32, which can tilt the television downward.

As shown in FIG. 10 and FIG. 14, in some embodiments of the present application, the television mount further includes a base fixing member 5, a first arm assembly 4, and a second arm assembly 40, each of the first arm assembly 4 and the second arm assembly 40 includes a first segment 41 and a second segment 42 hinged to each other; the first segment 41 of the first arm assembly 4 and the first segment 41 of the second arm assembly 40 are both hinged to the second adjustment bracket 32, and the second segment 42 of the first arm assembly 4 and the second segment 42 of the second arm assembly 40 are both hinged to the base fixing member 5.

In this embodiment, the base fixing member 5 serves as the base portion of the television mount. The base fixing member 5 is used to stably fix the entire television mount to a specific location, such as the floor, a wall, or other support structure. It provides a stable foundation for the entire mount system, ensuring the mount does not shift during use.

The first arm assembly 4 and the second arm assembly 40 each has a first segment 41 and a second segment 42 hinged to each other. This hinged design allows the segments of each arm assembly to rotate relative to each other. The first segment 41 of the first arm assembly 4 and the first segment 41 of the second arm assembly 40 are both hinged to the second adjustment bracket 32. This means the first arm assembly 4 and the second arm assembly 40 can perform corresponding angular adjustments as the second adjustment bracket 32 rotates. Meanwhile, the second segment 42 of the first arm assembly 4 and the second segment 42 of the second arm assembly 40 are both hinged to the base fixing member 5. This configuration forms a ring-shaped multi-link structure among the first arm assembly 4, the second arm assembly 40, the second adjustment bracket 32, and the base fixing member 5, allowing the television mount to adjust its position and angle relatively freely within a certain range. When the hinge axes of the first arm assembly 4 and the second arm assembly 40 are all arranged vertically, horizontal position and angle adjustment of the television mount can be achieved.

The above are only preferred embodiments of the present application and are not intended to limit the present application. Any modifications, equivalent substitutions, and improvements made within the spirit and principle of the present application shall be included in the protection scope of the present application.

What is claimed is:

1. A plug-in assembly, configured for a television mount, comprising:
a first plug-in member; wherein the first plug-in member comprises a first end and a second end, and the first end is provided with a first port; and
a second plug-in member; wherein the second plug-in member comprises a third end and a fourth end, the third end is provided with a plug-in portion, and the plug-in portion is configured to be plugged into the first port;
wherein the second end is provided with a blocking portion configured for preventing erroneous plugging of the second end, and/or the fourth end is provided with a blocking portion configured for preventing erroneous plugging of the fourth end.

2. The plug-in assembly according to claim 1, wherein the second end is provided with a second port, the second end is further provided with a first through hole, the first through hole penetrates through a side wall of the second port; and
the first through hole comprises a first flange hole, a first flange portion is formed on an inner wall of the second port along a periphery of the first flange hole, and the first flange portion forms the blocking portion.

3. The plug-in assembly according to claim 1, wherein the plug-in assembly further comprises a connecting member;
the first end is provided with a second through hole, the third end is provided with a third through hole;
when the plug-in portion is plugged into the first port, the second through hole and the third through hole are aligned, and the connecting member is inserted through the second through hole and the third through hole.

4. The plug-in assembly according to claim 3, wherein the third end is provided with a third port, and the third through hole penetrates through a side wall of the third port;
the third through hole comprises a second flange hole, a second flange portion is formed on an inner wall of the third port along a periphery of the second flange hole, and an inner wall of the second flange portion is provided with an internal thread; and
the connecting member comprises a screw, and the screw is connected with the internal thread.

5. The plug-in assembly according to claim 2, wherein the plug-in assembly further comprises a connecting member;
the first end is provided with a second through hole, the third end is provided with a third through hole;
when the plug-in portion is plugged into the first port, the second through hole and the third through hole are aligned, and the connecting member is inserted through the second through hole and the third through hole.

6. The plug-in assembly according to claim 1, wherein the third end is provided with a reduced-diameter portion, and the reduced-diameter portion forms the plug-in portion.

7. A television mount, comprising the plug-in assembly according to claim 1.

8. The television mount according to claim 7, wherein the television mount comprises a hanging strip assembly, the hanging strip assembly is provided with a hanging opening and a television mounting portion; and
the plug-in assembly is disposed along a horizontal direction, and the hanging strip assembly is hung on the plug-in assembly through the hanging opening.

9. The television mount according to claim 8, wherein the television mount comprises a plurality of plug-in assemblies, the plurality of plug-in assemblies comprise a first plug-in assembly and a second plug-in assembly, the first plug-in assembly and the second plug-in assembly are arranged along a height direction;
the hanging strip assembly comprises a plurality of hanging openings, the plurality of hanging openings comprise a first hanging opening and a second hanging opening, the first hanging opening is hung on the first plug-in assembly, the second hanging opening is hung on the second plug-in assembly; and
the hanging strip assembly comprises a locking member, at least one of the first hanging opening and the second hanging opening is a lockable hanging opening, one end of the locking member is hinged to one side of the lockable hanging opening, and an other end of the locking member is detachably connected to an other side of the lockable hanging opening, so that the locking member locks the plug-in assembly within the lockable hanging opening.

10. The television mount according to claim 8, wherein the television mount comprises an adjustment assembly, the adjustment assembly comprises a first adjustment bracket and a second adjustment bracket, and the first adjustment bracket is connected to the plug-in assembly; and
the first adjustment bracket comprises a hinge position and an adjustment hole arranged at an interval, the adjustment hole is an arc-shaped hole centered at the hinge position, one end of the second adjustment bracket is hinged at the hinge position, and an other end of the second adjustment bracket is provided with a guide member inserted through the arc-shaped hole.

11. The television mount according to claim 10, wherein the television mount further comprises a base fixing member, a first arm assembly, and a second arm assembly, each of the first arm assembly and the second arm assembly comprises a first segment and a second segment hinged to each other; and
the first segment of the first arm assembly and the first segment of the second arm assembly are both hinged to the second adjustment bracket, and the second segment of the first arm assembly and the second segment of the second arm assembly are both hinged to the base fixing member.

12. The television mount according to claim 7, wherein the second end is provided with a second port, the second end is further provided with a first through hole, the first through hole penetrates through a side wall of the second port; and
the first through hole comprises a first flange hole, a first flange portion is formed on an inner wall of the second port along a periphery of the first flange hole, and the first flange portion forms the blocking portion.

13. The television mount according to claim 7, wherein the plug-in assembly further comprises a connecting member;
the first end is provided with a second through hole, the third end is provided with a third through hole;
when the plug-in portion is plugged into the first port, the second through hole and the third through hole are aligned, and the connecting member is inserted through the second through hole and the third through hole.

14. The television mount according to claim 13, wherein the third end is provided with a third port, and the third through hole penetrates through a side wall of the third port;
the third through hole comprises a second flange hole, a second flange portion is formed on an inner wall of the third port along a periphery of the second flange hole, and an inner wall of the second flange portion is provided with an internal thread; and
the connecting member comprises a screw, and the screw is connected with the internal thread.

15. The television mount according to claim 7, wherein the third end is provided with a reduced-diameter portion, and the reduced-diameter portion forms the plug-in portion.
